(19) United States
(12) Patent Application Publication
(10) Pub. No.: US 2019/0194966 A1
(43) Pub. Date: Jun. 27, 2019

(54) POOL VALVE ASSEMBLY

(71) Applicant: Bestway Inflatables & Material Corp., Shanghai (CN)

(72) Inventors: Shuiyong HUANG, Shanghai (CN); Wenhua HU, Shanghai (CN); Changde WAN, Shanghai (CN); Zhibin CHEN, Shanghai (CN)

(21) Appl. No.: 15/861,643

(22) Filed: Jan. 3, 2018

(30) Foreign Application Priority Data
Dec. 21, 2017 (CN) 201721805535.1

(51) Int. Cl. E04H 4/12; F16K 3/02

(52) U.S. Cl. CPC E04H 4/1218; F16K 3/0281

(57) ABSTRACT

A valve assembly includes a valve body with a fluid upstream end and a fluid downstream end, a sliding plate disposed in the valve body and configured to be slidable between a first position and a second position relative to the valve body, wherein a continuous fluid channel is formed between the fluid upstream end and fluid downstream end when the sliding plate is positioned in the first position, and a continuous fluid channel is prevented between the fluid upstream end and fluid downstream end when the sliding plate is positioned in the second position. The valve assembly according to the present invention can easily control flow of fluid. And the structure is simple and the production cost is low.

### CROSS-REFERENCE TO RELATED APPLICATIONS

This application claims the priority of Chinese Patent Application No. 201721805535.1, filed Dec. 21, 2017, which is incorporated herein by reference in its entirety.

### TECHNICAL FIELD

The present disclosure generally relates to valve systems. In particular, a pool valve assembly for selectively enabling a fluid flow is provided.

### BACKGROUND OF THE INVENTION

Standard pool valve assemblies are generally known in the art. Some valve systems include selectively-sealable openings or one-way valves. As known in the art, above ground pools, which are often used outdoors, generally need a filter pump for filtration and cleaning. The filter pump is typically connected to the inlet and outlet of the above ground pools via tubes to achieve water circulation. During maintaining or cleaning filter element, the filter pump needs additional elements (e.g. plugs) to block the inlet and outlet to prevent water leakage. To simplify the blocking manner, a water valve is mounted to the inlet and the outlet. Though the water valve is easily operated, its structure is complicate and production costs can be high. However, conventional valve systems generally manipulate a fluid flow via an external toggle or removable plugs, or require the use of tools to operate. Accordingly, conventional valve systems are limited in their functionality and flexibility, and do not purposefully and effectively address these constraints. The present disclosure seeks to overcome some limitations and other drawbacks of the prior art, and to provide new features not heretofore available. A full discussion of the features and advantages of the present disclosure is deferred to the following detailed description, which proceeds with reference to the accompanying drawings.

### SUMMARY OF THE INVENTION

In some implementations of the present disclosure, a valve assembly is provided and includes a valve body with a fluid upstream end and a fluid downstream end, and a sliding plate disposed in the valve body is configured to be slidable between a first position and a second position relative to the valve body. A continuous fluid channel is formed between the fluid upstream end and fluid downstream end when the sliding plate is positioned in the first position, and a continuous fluid channel is prevented between the fluid upstream end and fluid downstream end when the sliding plate is positioned in the second position.

The sliding plate can have an opening, and the continuous fluid channel can be formed through the opening when the sliding plate is positioned in the first position.

The fluid upstream end can be provided with a tube for an installation, or connection, of the valve assembly to another device.

The valve assembly can further include a first slot and a second slot disposed on the side wall of the valve body. The first and second slots can be adapted for insertion of the sliding plate such that the sliding plate is slidable between the first position and the second position.

A guide member parallel with the valve body can be provided between the first slot and the second slot, and a slideway can be formed between the guide member for the sliding plate's sliding between the first slot and the second slot.

The valve assembly can further include a first positional groove and a second positional groove. The first and second positional grooves is disposed on one of either the valve body and the sliding plate, and a protrusion is disposed on the other of either the valve body and sliding plate. The protrusion can engage the first positional groove when the sliding plate is positioned in the first position, and the protrusion can engage the second positional groove when the sliding plate is positioned in the second position.

The valve assembly can further include a first positional groove and a second positional groove. The first and second positional grooves are disposed on either the guide member or the sliding plate, and a protrusion is disposed on the other of the guide member and sliding plate. The protrusion can engage the first positional groove when the sliding plate is positioned in the first position, and the protrusion can engage the second positional groove when the sliding plate is positioned in the second position.

The valve assembly can further include a seal ring disposed between a portion of the sliding plate and a portion of the valve body, and a sealing structure formed on the sliding plate. At least a portion of the sealing structure is cooperatively engageable with at least a portion of the seal ring to form a fluid seal between the fluid upstream end and the fluid downstream end when the sliding plate is positioned in the second position. The seal ring can be at least partially disposed within a seal ring seat formed in the valve body.

A sliding plate stop can be disposed at one end of the sliding plate. The sliding plate stop contacts a portion of the valve body when the sliding plate is disposed in the second position to limit a travel of the sliding plate relative to the valve body when the sliding plate is disposed in the second position.

A plate aperture abutment portion can be formed on the sliding plate and an abutment member can be formed on the valve body. The plate aperture abutment portion contacts the abutment member when the sliding plate is disposed in the first position to limit a travel of the sliding plate relative to the valve body when the sliding plate is disposed in the second position.

The valve assembly can further include a valve housing, and the valve body can be releasably connected to the valve housing. In one implementation, the valve body can be releasably connected to the valve housing via cooperative threading on the valve body and the valve housing.

In some aspects, the present disclosure provides a pool device that has a valve body with a fluid upstream end and a fluid downstream end. The pool device also has a sliding plate disposed in the valve body is configured to be slidable between a first position and a second position relative to the valve body. A continuous fluid channel is formed between the fluid upstream end and the fluid downstream end when the sliding plate is positioned in the first position, and a continuous fluid channel is prevented between the fluid upstream end and fluid downstream end when the sliding plate is positioned in the second position.

The pool device can further include a mounting member. The mounting member includes a connection tube and a connection part, which can also be called an attachment device. The connection part can be configured to connect the connection tube to a wall of a pool.

The fluid upstream end can be provided with an intake tube for installation of the valve assembly. The intake tube can be configured to insert into the connection tube.

The valve assembly according to the present disclosure can easily control flow of fluid without the need to use additional tools. The structure is also simple and its production cost is low.

### BRIEF DESCRIPTION OF THE DRAWINGS

To understand the present disclosure, it will now be described by way of example, with reference to the accompanying drawings in which implementations of the disclosures are illustrated and, together with the descriptions below, serve to explain the principles of the disclosure.

FIG. 1 is a perspective view of a valve assembly according to exemplary implementations of the present disclosure.

FIG. 2 is an exploded perspective view of a valve assembly according to exemplary implementations of the present disclosure.

FIG. 3 is an exploded perspective view of the valve assembly of FIG. 1, showing the valve assembly from a different perspective than that shown in FIG. 2.

FIG. 4A is a cross-sectional view of the valve assembly of FIG. 1 showing a sliding plate in a first position, taken along line 4A-4A of FIG. 1.

FIG. 4B is a cross-sectional view of the valve assembly of FIG. 4A, further illustrating a portion of a pool body and a sliding plate in a first position.

FIG. 5 is a cross sectional-view of the valve assembly of FIG. 4B, showing a sliding plate in a second position.

FIG. 6 is an end view of a valve body according to exemplary implementations of the present disclosure, showing a sliding plate in a first position.

FIG. 7 is a cross-sectional view of the valve body of FIG. 6 showing a sliding plate in a first position, taken along line 7-7 of FIG. 6.

FIG. 8 is a cross-sectional view of the valve body of FIG. 7, showing a sliding plate in a second position.

### DETAILED DESCRIPTION

While a valve assembly 100 discussed herein may be implemented in many different forms, the disclosure will show in the drawings, and will herein describe in detail, implementations with the understanding that the present description is to be considered as an exemplification of the principles of the valve assembly 100 and is not intended to limit the broad aspects of the disclosure to the implementations illustrated.

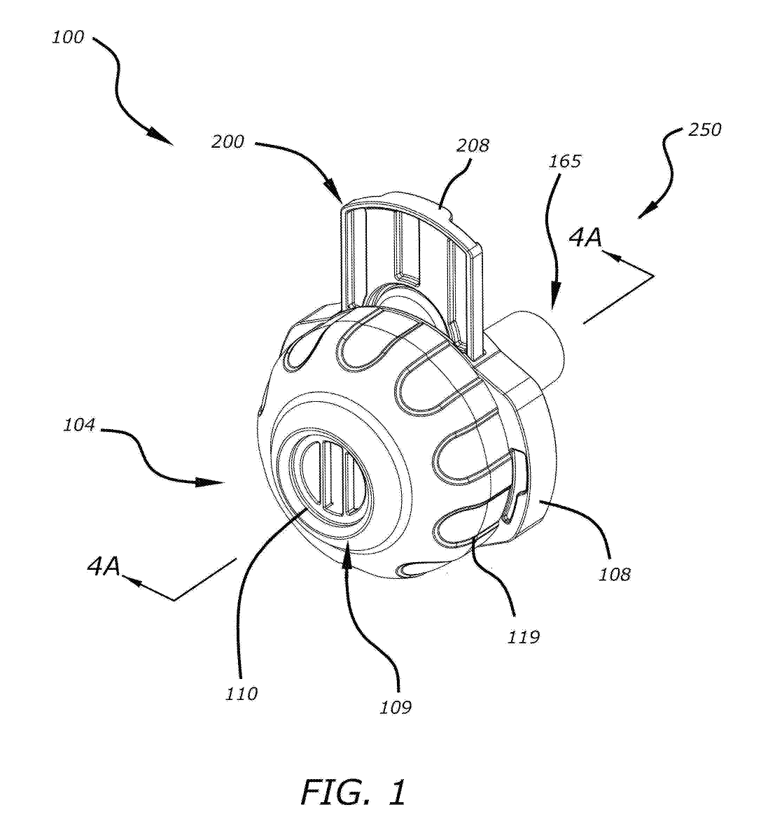

Referring now to the figures, and initially to FIGS. 1-3, the valve assembly 100 includes a valve housing 104 and a valve body 108. Generally, the valve assembly 100 selectively permits the passage of a fluid through the valve assembly 100 depending upon relative positions and interactions of various constituent elements. The valve housing 104 is releasably, or permanently, attached to the valve body 108, as will be described below in further detail.

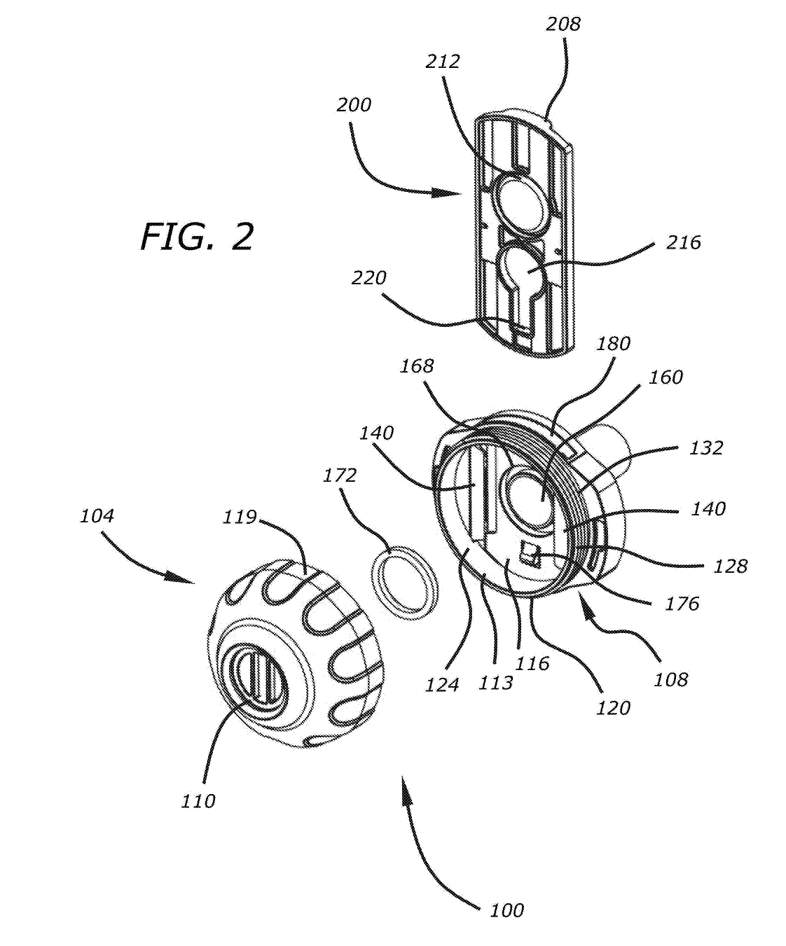

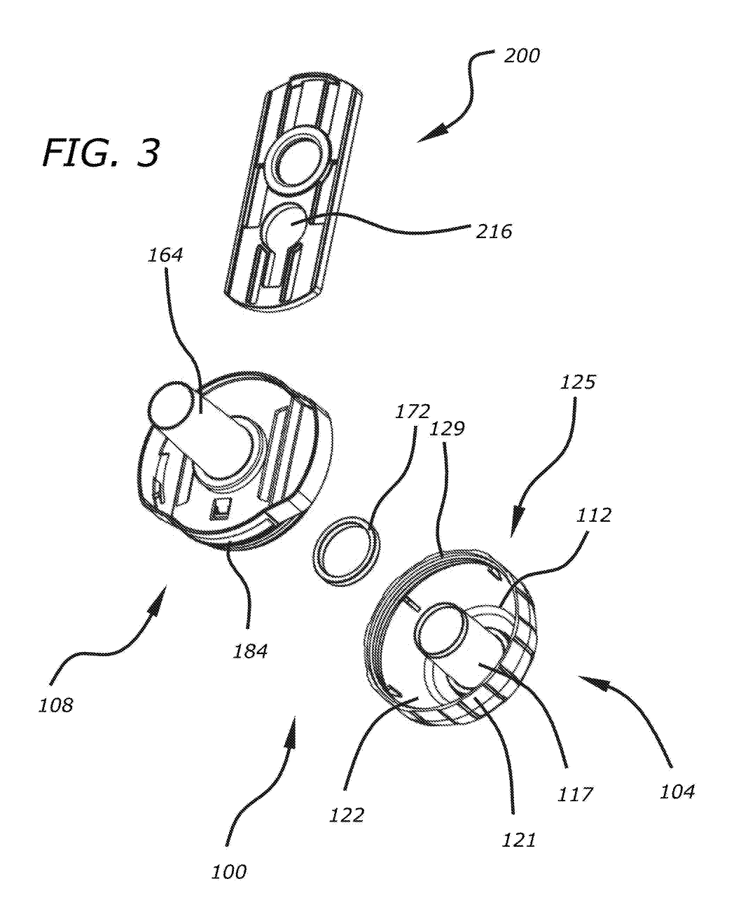

Turning to FIGS. 2 and 3, the valve housing 104 defines an outlet 110 and a valve housing cavity 112. An outlet tube 117, which may be generally cylindrical or frusto-conical in shape, extends from the outlet 110 through the valve housing cavity 112. In some implementations, surface irregularities 119 are disposed on a valve housing outer surface 121. The valve housing outer surface 121 is substantially opposite a valve housing inner surface 122, which substantially defines the valve housing cavity 112. In some implementations, the valve assembly 100 includes a fluid downstream end 109, which can be defined by the outlet 110.

A peripheral housing region 125 releasably joins the valve housing 104 to the valve body 108. In some implementations, the peripheral housing region 125 includes housing threading 129, as will be described below.

The valve body 108 defines a valve body cavity 113. In particular, the valve body cavity 113 is substantially defined by an interior face 116 and an inner surface 124 of a circumferential wall 120. The circumferential wall 120 also defines an outer surface 128 disposed substantially opposite the inner surface 124 of the circumferential wall 120. Valve body threading 132 can be disposed on the outer surface 128.

An inlet 160 is disposed at one end of the valve body 108. An intake tube 164 in fluid communication with the inlet 160 extends from the valve body 108, and the intake tube 164 may be generally cylindrical or frusto-conical in shape. In some implementations, the valve assembly 100 includes a fluid upstream end 165, which can be defined by a portion of the intake tube 164. In some implementations, the intake tube 164 facilitates the installation of the valve assembly 100 to another device, or a pool, which will be described below in further detail.

A seal ring seat 168 is disposed substantially around the inlet 160. The seal ring seat 168 may be formed in the interior face 116, and a seal ring 172 is at least partially disposed within the seal ring seat 168. The seal ring 172 may be formed of rubber, a polymer, a ceramic, a metal or any other material known to those in the art that can effectively prevent, or limit, a fluid flow. Additionally, a first slot 180 and a second slot 184 can be formed the valve body 108 or the valve housing 104 to receive a sliding plate 200.

One or more guide members 140, or baffles are disposed in, or on, the valve body 108 as best shown in FIGS. 7 and 8. The guide members 140 serve as a sliding surface, or slideway, for a sliding plate 200, as will be described below in further detail. Further, a first positional groove 144 and a second positional groove 148 are disposed on, interior face 116, circumferential wall 120 of the valve body 108 or guide member 140. While FIGS. 7 and 8 illustrate the first positional groove 144 and the second positional groove 148 as being disposed on the guide member 140, it is to be understood that this disclosure is not limited to the specific configurations shown.

The FIGS. also illustrate a sliding plate 200 in isolation (FIGS. 2 and 3) and within other elements of the valve assembly 100. The sliding plate 200 can be movably disposed within the valve assembly 100 to selectively permit, prevent or reduce a fluid flow through the valve assembly 100. In some implementations, the sliding plate 200 is slidably disposed within the first slot 180 and the second slot 184 to selectively permit, prevent or reduce a fluid flow through the valve assembly 100. It will be understood that other dynamic relationships between the sliding plate 200 and other elements of the valve assembly 100 are also within the scope of this disclosure, such as, for example, pivotal movement or translational movement along any axis.

As best illustrated in FIGS. 7 and 8, the sliding plate 200 includes a protrusion 204. The protrusion 204 extends from the sliding plate 200 and can engage with first positional groove 144 or second positional groove 148. In some implementations, the protrusion 204 releasably engages with the first positional groove 144 or second positional groove 148 until the sliding plate 200 is manipulated with a sufficient degree of force by a user.

A sliding plate stop 208, is formed at one end of the sliding plate 200, and can extend substantially perpendicularly from the sliding plate 200. In some implementations, the sliding plate stop can include a substantially planar shape, a curved shape or a flap shape. A sealing structure 212 and a sliding plate aperture 216 are also formed on the sliding plate 200. The sealing structure 212 can engage with the seal ring 172 in certain arrangements of the valve assembly 100 (for example, the protrusion 204 engages the first position groove 144). In particular, the sealing structure 212 can include a circular shape and forms a fluid-tight, substantially fluid-tight or a partial seal when the sealing structure 212 is engaged with the seal ring 172. Further, the sealing structure 212 comprises a circular rib formed on the sliding plate 200.

The sliding plate aperture 216 extends completely through a portion of the sliding plate 200. Further, a plate aperture abutment portion 220 is disposed on a portion of the sliding plate 200 defining the sliding plate aperture 216.

In operation, the valve assembly 100 selectively permits the passage of a fluid through the valve assembly 100. Initially, the valve housing 104 can be releasably joined to the valve body 108 by the engagement of the housing threading 129 and the valve body threading 132. In some implementations, the surface irregularities 119 can aid a user in gripping the valve housing 104 such that the user can rotate the valve housing 104 relative to the valve body 108 to releaseably join, or separate, the valve housing 104 to the valve body 108. However, it is to be understood that mechanical, electromechanical or chemical attachment technologies, such as clips, fasteners, snaps, clasps, adhesives, magnets, electromagnets or any other such technology known to those skilled in the art suitable to releasably join the valve housing 104 and the valve body 108 are within the scope of this disclosure.

When the valve housing 104 is releasably attached to the valve body 108, the sliding plate 200 can be disposed in a plurality of positions relative to valve housing 104 and the valve body 108. In some implementations, the sliding plate 200 can be disposed in at least a first position 250, or an open position, and a second position 260, or a sealed position. The first position 250 can correspond to the valve assembly 100 facilitating a fluid flow through the valve assembly 100. The second position 260 can correspond to the valve assembly 100 permitting, preventing or reducing a fluid flow through the valve assembly 100.

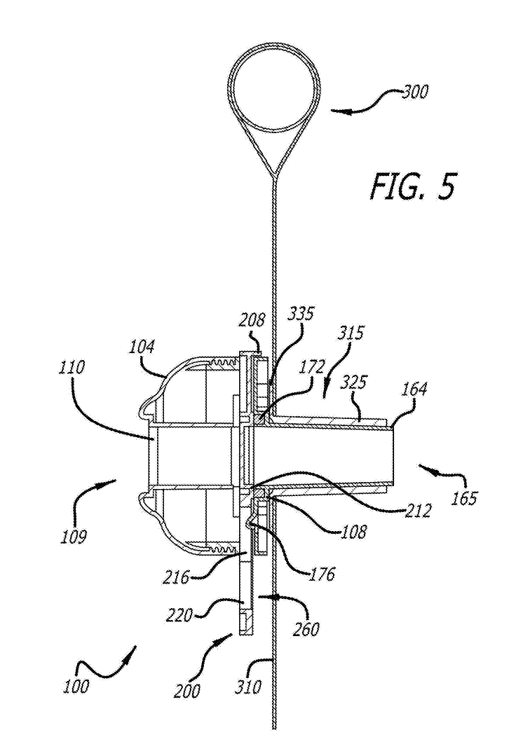

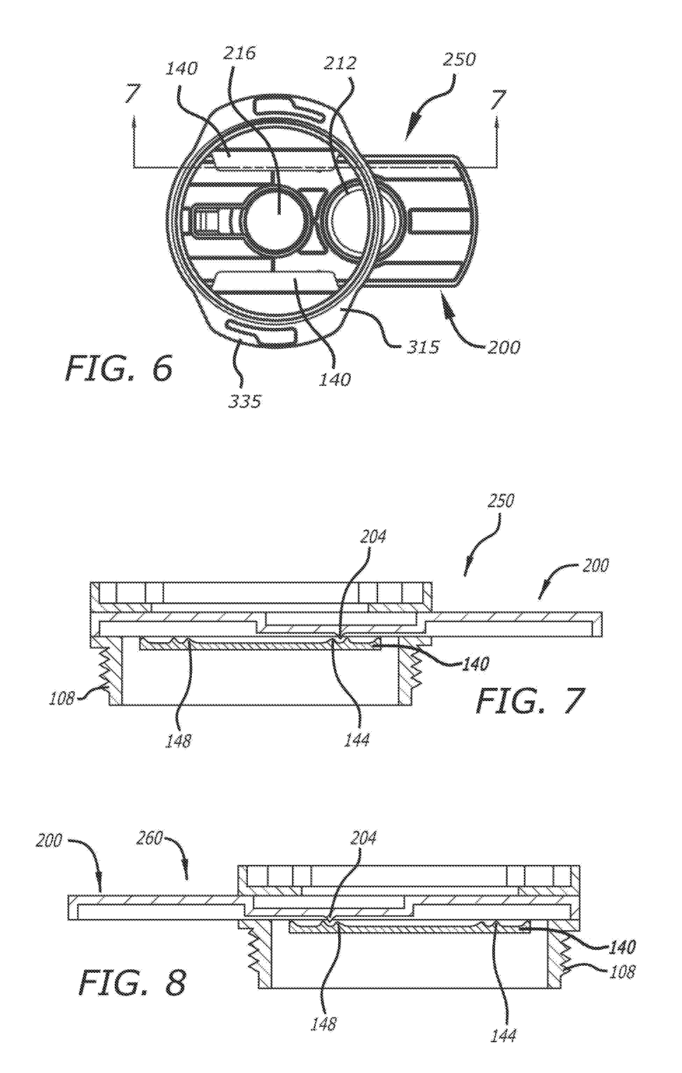

As described above, the guide member 140 serves as a sliding surface, or slideway, for the sliding plate 200, which is also disposed within the first and second slots 180, 184. Accordingly, the sliding plate 200 can slide between the first position 250, as best shown in FIGS. 1, 4A, 4B, 6 and 7, and the second position 260, as best shown in FIGS. 5 and 8, guided by the guide member 140 and first and second slots 180, 184.

In the first position 250, the protrusion 204 releasably engages with the first positional groove 144, best seen in FIG. 7. This engagement can include the protrusion 204, and thus the sliding plate 200 as the protrusion 204 is formed on the sliding plate 200, being disposed in the first position 250 until the sliding plate 200 is manipulated with a sufficient degree of force by a user. Additionally in the first position 250, the plate aperture abutment portion 220 contacts the abutment member 176, thus limiting sliding travel of the sliding plate 200 in a particular direction when the tab aperture abutment portion 220 contacts the abutment member 176. When the sliding plate 200 is disposed in the first position 250, a fluid channel 259 exists through the intake tube 164, inlet 160, sliding plate aperture 216, outlet tube 117 and outlet 110 to thereby permit a fluid flow through the valve assembly 100.

When the sliding plate 200 is disposed in the first position 250 and is manipulated with the threshold degree of force by a user, the protrusion 204 disengages with the first positional groove 144. The sliding plate 200 can then be slid into the second position 260. In the second position 260, the protrusion 204 releasably engages with the second positional groove 148, best seen in FIG. 8. This engagement can include the protrusion 204, and thus the sliding plate 200 as the protrusion 204 is formed on the sliding plate 200, being disposed in the second position 260 until the sliding plate 200 is manipulated with a sufficient degree of force by a user.

Additionally, in the second position 260, the sliding plate stop 208 contacts valve housing 104 and/or valve body 108 proximate the first slot 180, thus limiting sliding travel of the sliding plate 200 in a particular direction when the tab stop 208 contacts one or more of the valve assembly 100, valve housing 104 and valve body 108.

When the sliding plate 200 is disposed in the second position 260, the seal ring 172 engages with the sealing structure 212 on the sliding plate 200. This engagement between the seal ring 172 and the sealing structure 212 forms a fluid-tight, substantially fluid-tight or a partial seal when the sealing structure 212 is engaged with the seal ring 172. Thus, when the sliding plate 200 is disposed in the second position 260, fluid is partially, or completely, prevented from flowing through the valve assembly 100.

The first positional groove 144 and second positional groove 148 are described as being disposed on interior face 116, circumferential wall 120 of the valve body 108 or guide member 140, and the protrusion 204 is described as being disposed on the sliding plate 200. However, it will be understood that the protrusion 204 could also be disposed on interior face 116, circumferential wall 120 of the valve body 108 and guide member 140, and the first positional groove 144 and second positional groove 148 could be disposed on the sliding plate 200 without departing from the scope of this disclosure.

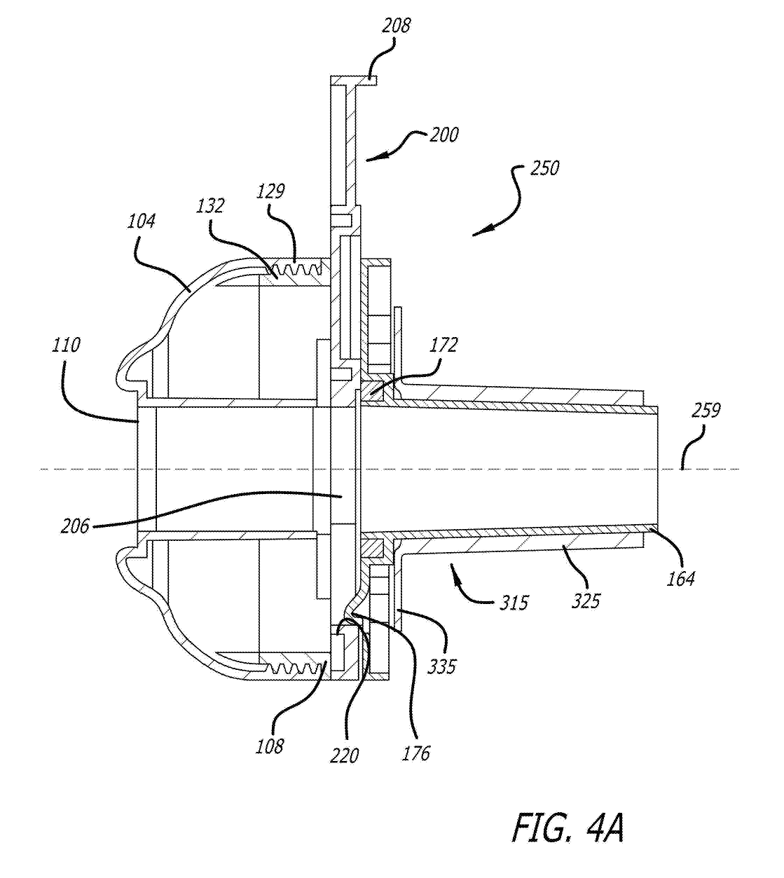

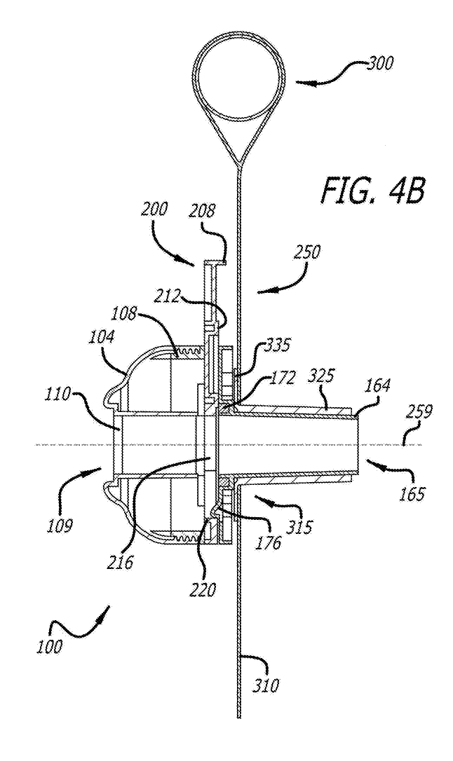

Turning again to FIGS. 4 and 5, the valve assembly 100 can be releasably attached to a pool 300, or a pool body. In particular, the valve assembly 100 can be releasably attached to a wall 310 of the pool 300.

In some implementations, the pool 300 includes a mounting member 315. The mounting member 315 can include a connection tube 325 and a connection part 335. The connection part 335 is configured to either permanently or releasably connect the connection tube 325 to the wall 310. Further, in some implementations, the fluid upstream end 165 is provided with the intake tube 164 for installation of the valve assembly 100, and the intake tube 164 is configured to insert into the connection tube 325.

It is to be understood that all described elements and features in this disclosure can be formed of any number of materials including, but not limited to, polymers, rubbers, foams, ceramics, metals, metal alloys or any other material known to those skilled in the art. In particular, the elements of this disclosure may be formed of polyvinyl chloride (PVC) with a hardness of 20±5 Parts per Hundred Resin (PHR).

While some implementations have been illustrated and described, numerous modifications come to mind without significantly departing from the spirit of the disclosure, and the scope of protection is only limited by the scope of the accompanying claims.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative implementations disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each article of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A valve assembly, comprising:
a valve body with a fluid upstream end and a fluid downstream end; and
a sliding plate disposed in the valve body and configured to be slidable between a first position and a second position relative to the valve body;
wherein a continuous fluid channel is formed between the fluid upstream end and fluid downstream end when the sliding plate is positioned in the first position, and a continuous fluid channel is prevented between the fluid upstream end and fluid downstream end when the sliding plate is positioned in the second position.

2. The valve assembly of claim 1, wherein the sliding plate has an opening, and the continuous fluid channel is through the opening when the sliding plate is positioned in the first position.

3. The valve assembly of claim 1, wherein the fluid upstream end is provided with a tube for an installation of the valve assembly to another device.

4. The valve assembly of claim 1, further comprising:
a first slot and a second slot disposed on the side wall of the valve body;
wherein, the first and second slots are adapted for insertion of the sliding plate such that the sliding plate is slidable between the first position and the second position.

5. The valve assembly of claim 4, wherein a guide member parallel with the valve body is provided between the first slot and the second slot, and a slideway is formed between the guide member for the sliding plate's sliding between the first slot and the second slot.

6. The valve assembly of claim 4, further comprising:
a first positional groove and a second positional groove, the first and second positional grooves being disposed on one of either the valve body and the sliding plate, and a protrusion disposed on the other of either the valve body and sliding plate;
wherein, the protrusion engages the first positional groove when the sliding plate is positioned in the first position, and the protrusion engages the second positional groove when the sliding plate is positioned in the second position.

7. The valve assembly of claim 5, further comprising:
a first positional groove and a second positional groove, the first and second positional grooves being disposed on one of either the guide member and the sliding plate, and a protrusion disposed on the other of either the guide member and sliding plate;
wherein, the protrusion engages the first positional groove when the sliding plate is positioned in the first position, and the protrusion engages the second positional groove when the sliding plate is positioned in the second position.

8. The valve assembly of claim 1, further comprising:
a seal ring disposed between a portion of the sliding plate and a portion of the valve body; and
a sealing structure formed on the sliding plate, at least a portion of the sealing structure being cooperatively engageable with at least a portion of the seal ring to form a fluid seal between the fluid upstream end and the fluid downstream end when the sliding plate is positioned in the second position.

9. The valve assembly of claim 8, wherein the seal ring is at least partially disposed within a seal ring seat formed in the valve body.

10. The valve assembly of claim 1, wherein a sliding plate stop is disposed at one end of the sliding plate, the sliding plate stop contacting a portion of the valve body when the sliding plate is disposed in the second position to limit a travel of the sliding plate relative to the valve body when the sliding plate is disposed in the second position.

11. The valve assembly of claim 1, wherein a plate aperture abutment portion is formed on the sliding plate and an abutment member is formed on the valve body, the plate aperture abutment portion contacting the abutment member when the sliding plate is disposed in the first position to limit a travel of the sliding plate relative to the valve body when the sliding plate is disposed in the second position.

12. The valve assembly of claim 1, wherein the valve assembly further comprises a valve housing, and the valve body is releasably connected to the valve housing.

13. The valve assembly of claim 1, wherein the valve body is releasably connected to the valve housing via cooperative threading on the valve body and the valve housing.

14. A pool device, comprising:
a valve body with a fluid upstream end and a fluid downstream end; and
a sliding plate disposed in the valve body and configured to be slidable between a first position and a second position relative to the valve body;
wherein a continuous fluid channel is formed between the fluid upstream end and the fluid downstream end when the sliding plate is positioned in the first position, and a continuous fluid channel is prevented between the fluid upstream end and fluid downstream end when the sliding plate is positioned in the second position.

15. The pool device of claim 14, wherein, the pool device further comprises a mounting member, the mounting member including a connection tube and a connection part, and the connection part is configured to connect the connection tube to a wall of a pool.

16. The pool device of claim 15, wherein the fluid upstream end is provided with an intake tube for installation of the valve assembly, and the intake tube is configured to insert into the connection tube.
